(19) United States
(12) Patent Application Publication
(10) Pub. No.: US 2016/0028112 A1
(43) Pub. Date: Jan. 28, 2016

(54) GUM-LIKE ELECTROLYTES AND METHODS OF MAKING THE SAME

(71) Applicant: WASHINGTON STATE UNIVERSITY, Pullman,, WA (US)

(72) Inventors: Wei-Hong ZHONG, Pullman, WA (US); Yu WANG, Pullman, WA (US); Bin LI, Pullman, WA (US)

(21) Appl. No.: 14/777,282

(22) PCT Filed: Jan. 23, 2014
(86) PCT No.: PCT/US14/12727

§ 371 Date: Sep. 15, 2015

Related U.S. Application Data
(60) Provisional application No. 61/789,972, filed on Mar. 15, 2013.
(60) Provisional application No. 61/823,377, filed on May 14, 2013.

(51) Int. Cl. H01M 10/0565; H01G 9/032

(52) U.S. Cl. CPC H01M 10/0565; H01G 9/032; H01M 2300/0082

(57) ABSTRACT

A gum like electrolyte composition and methods for making the composition are disclosed herein. The gum-like electrolyte composition may include a mixture of at least one wax particle, at least one electrolyte, and a polymer matrix comprising at least one polymer, wherein the wax particle and the electrolyte are dispersed in the polymer matrix, and wherein mixture is a malleable material.

### CROSS-REFERENCE TO RELATED APPLICATIONS

This application claims the priority benefit of U.S. Provisional Patent Application No. 61/789,972, filed Mar. 15, 2013 and entitled “Gum-Like Electrolytes with Thermal-Protection Capability for Safe, High-Performance Lithium-Ion Batteries” and U.S. Provisional Patent Application No. 61/823,377, filed May 14, 2013 and entitled “Gum-Like Electrolytes with Thermal-Protection Capability for Safe, High-Performance Lithium-Ion Batteries (2),” which are incorporated herein by reference in their entireties.

### BACKGROUND

The demand for advanced conformable energy storage devices, such as batteries and capacitors, has been increasing. Since lithium ion batteries (LIBs) have become the most favorable choice for electronics, electric vehicles, aircraft, bio-medical electronics, and the like, various industries have particularly focused on the development of high-performance and safe LIBs.

However, safety issues can arise from the use of LIB technology. For example, in LIBs that use a liquid state electrolyte such as an ionic liquid electrolyte, leakage or gas-generating reactions at high temperatures can be causes for concern. In general, safety issues associated with the LIB technology may include leakage, explosions due to pressure build up within the battery, and extreme overheating of the battery.

Others have attempted to remedy these safety issues by using gel electrolytes in LIBs because gel electrolytes possess high ionic conductivity and retain desirable mechanical properties. However, such gel electrolytes still require a substantial amount of liquid electrolyte to function in a LIB, which results in the same issues observed in liquid electrolyte LIBs.

Solid polymer electrolytes (SPEs) have also been used to alleviate safety concerns. However, the low ionic conductivity and possible electrolyte/electrode interface problems have limited the development and functional applications of SPEs.

Various sensors or additives, such as redox shuttles or polymerizable organics, have also been attempted. However, these sensors or additives may require certain conditions to be met for the battery to properly function. For example, the use of redox shuttles requires a liquid environment to function properly because diffusion of redox shuttles through the electrolyte must be fast enough to stabilize the voltage of batteries when overcharging. Such a requirement is not suitable for the design flexibility of next-generation batteries. Moreover, a liquid environment is also a precondition for the growth of lithium dendrites, which causes LIBs to suffer from poor safety and cycle performance.

### SUMMARY

In an embodiment, a method of forming a gum-like electrolyte composition may include providing a wax emulsion, adding at least one electrolyte to the wax emulsion to obtain an electrolytic wax emulsion, and adding a polymer solution to the electrolytic wax emulsion to obtain a mixture. The polymer solution may include a polymer, and a solvent. The method may further include removing the solvent from the mixture to obtain a gum-like electrolyte composition.

In an embodiment, a gum-like electrolyte composition may include a mixture of at least one wax particle, at least one electrolyte, and a polymer matrix having at least one polymer. The wax particle and the electrolyte may be dispersed in the polymer matrix. The mixture may be a malleable material.

In an embodiment, an article of manufacture may include a gum-like mixture of at least one wax particle, at least one electrolyte, and a polymer matrix having at least one polymer. The wax particle and the electrolyte may be dispersed in the polymer matrix. The mixture may be a malleable material.

### BRIEF DESCRIPTION OF THE DRAWINGS

FIG. 1 depicts a portion of an illustrative gum-like electrolyte composition according to an embodiment.

FIG. 2 depicts an illustrative core-shell particle of a gum-like electrolyte composition according to an embodiment.

FIG. 3 depicts an illustrative diagram of a gum-like electrolyte composition between electrodes at (a) a first temperature and (b) a higher second temperature.

FIG. 4 depicts an illustrative schematic diagram of a method of forming a gum-like electrolyte composition according to an embodiment.

FIG. 5 depicts a flow diagram of a method of forming a gum-like electrolyte composition according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present disclosure relates generally to gum-like electrolyte compositions that can be used in conductive adhesives or electrical storage devices, such as batteries and the like. Particularly, the gum-like electrolyte compositions disclosed herein have a gum-like or malleable quality that allows the solution to be used safely in an electrical storage device with less concern for leakage, gas build up, and excessive heat generated by the electrical storage device. Such compositions may exhibit a high ionic conductivity and may maintain structural integrity under arbitrary deformations, such as, for example, twisting, compression, stretching, and/or the like. Such compositions may also exhibit desirable mechanical properties such as modulus, flexibility, or extensibility (for example, an elastic modulus of about 0.1 MPa at a frequency of 5 Hz) and adhesive properties, as will be described in greater detail herein.

When used in a battery or conductive adhesive, a gum-like electrolyte composition may generally be placed between one or more electrodes, such as, for example, two electrodes. As will be described in greater detail herein, a gum-like electrolyte composition may be placed in contact with the one or more electrodes and configured to form a nonconductive barrier on the electrodes under certain conditions. The electrodes are not limited by this disclosure, and may generally be any electrodes commonly known in the art for use in energy storage devices or conductive adhesives. Illustrative electrodes may be made of lithium cobalt oxide, lithium metal, sodium metal, lithium iron phosphate, sodium iron pyrophosphate, lithium nickel manganese cobalt, lithium iron fluorophosphates, lithium manganese oxide, silicon, carbon nanotubes, graphite, graphene, carbon nanofiber, carbon fibers, vanadium (V) oxide, and the like, as well as any combination thereof.

The energy storage device is not limited by this disclosure, and may generally be any article of manufacture containing any number of components, particularly components commonly used in energy storage devices or conductive adhesives. Illustrative components include temperature sensors, voltage convertors, regulator circuits, voltage taps, battery charge state monitors, flexible batteries, stretchable batteries, flexible batteries, stretchable capacitors, ionic conductive binders, film separators, and/or the like.

In some embodiments, the gum-like electrolyte composition may include a mixture of at least one wax particle, at least one electrolyte; and a polymer matrix that includes at least one polymer. The at least one wax particle and the at least one electrolyte may be dispersed in the polymer matrix. The at least one wax particle may be at least partially encased by the at least one electrolyte to form at least one core-shell particle. The at least one core-shell particle may be dispersed in the polymer matrix. The polymer matrix can be a polymer chain network such that the at least one core-shell particle may be arranged in the polymer chain network.

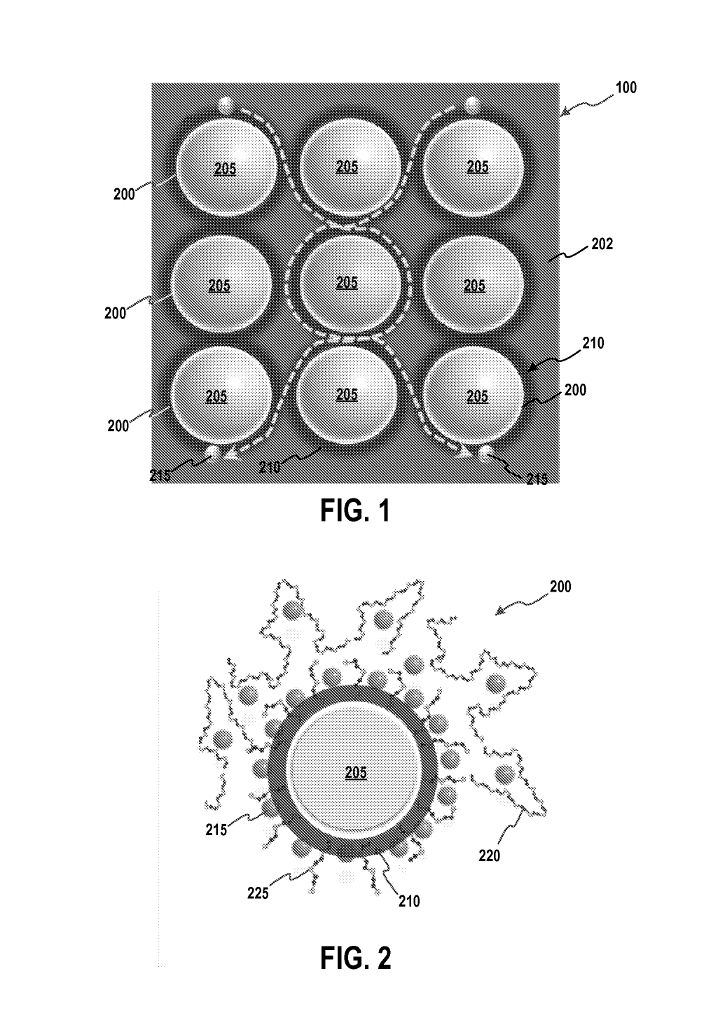

FIG. 1 depicts a gum-like electrolyte composition, generally designated 100, according to an embodiment. The gum-like electrolyte composition 100 may generally be a mixture having at least one core-shell particle 200, and a polymer matrix 202. The core-shell particle 200 includes an electrolyte 210 encasing a wax particle 205. In some embodiments, a plurality of core wax particles 205 may provide surfaces for localizing the electrolyte 210 shell. The core-shell particles 200 may be arranged in a structured manner, such as in the polymer matrix 202 which can be a polymer chain network, or the like. In some embodiments, the gum-like electrolyte composition 100 may have a multi-network structure. In some embodiments, the multi-network structure may be a double percolation network structure such as a percolation network of a liquid electrolyte 210 supported by a packing network of the core wax particles 205. Such a liquid percolation network may allow for various pathways for transporting ions 215 (as indicated by the dashed arrows) present in the liquid electrolyte 205, the polymer matrix 202, or both.

In various embodiments, the core-shell particles 200 may have a spacing between one another. In some embodiments, the spacing between any two core-shell particles 200 may be about 50 nanometers (nm) to about 500 nm, such as about 50 nm, about 100 nm, about 200 nm, about 300 nm, about 400 nm, about 500 nm, or any value or range between any two of these values (including endpoints). Such a spacing between particles 200 may provide a sufficient ratio of wax particles 205 to polymer matrix 202 (FIG. 2), as described in greater detail herein. In some embodiments, the ratio of the wax particles to the polymer matrix, by weight, is about 0.2 to about 3, such as about 0.2, about 0.5, about 1, about 2, about 3, or any value or range between any two of these values (including endpoints). This ratio may provide a large surface area of the gum-like electrolyte composition, which can contribute to strong adhesion.

In various embodiments, the gum-like electrolyte composition 100 may exhibit adhesive properties that may allow the composition to adhere to any surface. The gum-like electrolyte composition 100 may be defined by an average adhesive strength, which is expressed by the formula:

F_{max/A}

where Fₘₐₓ is a maximum force that the composition 100 can hold and A is a contact area between the composition and a surface to which the composition is adhering. In some embodiments, the average adhesive strength is at least about 0.1 MPa, or about 0.03 MPa to about 1 MPa, such as about 0.03 MPa, about 0.05 MPa, about 0.1 MPa, about 0.2 MPa, about 0.3 MPa, about 0.4 MPa, about 0.5 MPa, about 0.6 MPa, about 0.7 MPa, about 0.8 MPa, about 0.9 MPa, about 1 MPa, or any value or range between any two of these values (including endpoints. In some embodiments, the average adhesive strength may be about 0.34 MPa. In some embodiments, the composition 100 may sufficiently wet a surface to which it adheres to allow for a defect-free (no voids) or a substantially defect-free attachment to the surface. Such a defect-free or a substantially defect-free attachment may allow for increased adhesive strength, as described herein.

FIG. 2 depicts an illustrative core-shell particle 200 dispersed in the polymer matrix 202 according to an embodiment. In some embodiments, the polymer matrix 202 may contain one or more polymers 220. In some embodiments, the wax particle 205 may have one or more surfactant molecules 225 at its surface, as described in greater detail herein.

In some embodiments, the mixture of the wax particle 205, the electrolyte 210, and the polymer matrix 202 may include a liquid phase in an amount of about 10% by weight of the mixture to about 70% by weight of the mixture. Specific examples include about 10% liquid by weight, about 15% liquid by weight, about 20% liquid by weight, about 25% liquid by weight, about 30% liquid by weight, about 35% liquid by weight, about 40% liquid by weight, about 45% liquid by weight, about 50% liquid by weight, about 55% liquid by weight, about 60% liquid by weight, about 65% liquid by weight, about 70% liquid by weight, or any value or range between any two of these values (including endpoints). The liquid phase may, for example, be electrolyte 210 that is localized on the wax particles 205 of the core-shell particles 200. In particular embodiments, the mixture may include a liquid phase in an amount of about 40% by weight of the mixture to about 70% by weight of the mixture to provide that the mixture exhibits gum-like properties. In some embodiments, the electrolyte 210 may be a liquid electrolyte. In some embodiments, the mixture may be an elastic gel. The elastic gel may generally be a gel with elastic-like qualities that allow the gel to retain its structure under arbitrary deformations. In some embodiments, the mixture may be a film. In some embodiments, the mixture may be a fiber.

In various embodiments, a core portion of the core-shell particle 200 may contain at least one wax particle 205. In some embodiments, a shell portion of the core-shell particle 200 may contain the at least one electrolyte 210. In some embodiments, the shell portion may encase or substantially encase the core portion.

In various embodiments, the wax particle 205 may generally be a thermally sensitive wax particle. In some embodiments, the melting point of the wax particle 205 may correspond to an electrochemical reaction temperature (Tₐ) of the electrolyte 210. As such, when the gum-like electrolyte composition 100 is adhered to one or more electrodes, the wax particle 205 melts at the electrochemical reaction temperature to form a non-conductive barrier between the electrolyte 210 and the electrode, thereby preventing or reducing the potential for an electrochemical reaction, as described in greater detail herein. In some embodiments, the wax particle 205 may have a melting point of about 35° C. to about 260° C. Specific examples of melting points include about 35° C., about 50° C., about 75° C., about 100° C., about 125° C., about 150° C., about 175° C., about 200° C., about 225° C., about 250° C., about 260° C., or any value or range between any two of these values, including endpoints. In some embodiments, the melting point may be about 44° C. to about 54° C. In some embodiments, the melting point may be about 46° C. to about 68° C. In some embodiments, the melting point may be about 62° C. to about 65° C. In some embodiments, the melting point may be about 68.5° C. to about 72.5° C. In some embodiments, the melting point may be about 82° C. to about 86° C. In some embodiments, the melting point may be about 130° C.

Illustrative waxes that may be used for the wax particle include paraffin, paraffin wax, soy wax, polypropylene, polyethylene, montan wax, candelilla wax, carnauba wax, beeswax, polyethylene wax, and maleated hydrocarbons. Paraffin and paraffin wax are not limited by this disclosure, and may include any mixture of hydrocarbon molecules having about 20 carbon atoms to about 40 carbon atoms. In addition, soy wax is not limited by this disclosure, and may be any wax obtained from soybean oil and/or the like. Montan wax is likewise not limited by this disclosure, and may generally be any wax obtained from lignite.

In various embodiments, the wax particle 205 may be a wax emulsion. In some embodiments, the wax particle 205 may be formed from a wax emulsion. As described in greater detail herein, the wax emulsion may include at least one wax and at least one surfactant. In some embodiments, the wax may be present in the wax emulsion in an amount of about 5% by weight to about 50% by weight, such as about 5% by weight, about 10% by weight, about 15% by weight, about 20% by weight, about 25% by weight, about 30% by weight, about 35% by weight, about 40% by weight, about 45% by weight, about 50% by weight, or any value or range between any two of these values (including endpoints).

As previously described herein, the surfactant may be present in the wax emulsion. In some embodiments, the surfactant 225 may be present in the electrolyte 210. Thus, as shown in FIG. 1, the surfactant 225 may be at least one molecule present on a surface of the wax particle 205, and extending outward into the electrolyte 210 and the polymer chain 220 portion. The surfactant is not limited by this disclosure, and may be any surfactant, particularly surfactants commonly used to obtain wax emulsions and/or in gum-like compounds. Illustrative surfactants include, but are not limited to, at least one of polyethylene-block-poly(ethylene glycol), a lithium dodecyl sulfate, sodium dodecyl sulfate, a sucrose distearate, a sucrose monostearate, a phosphatidylethanolamine, a polyacrylic acid, a polyethylacetate, a dimethylacrylamide, an n-isopropylacrylamide, a polyvinylpyrrolidone, a polyethyleneimine, sorbitan, an alkyl polyglycoside, a sorbitan ester, a methyl glucoside ester, an amine ethoxylate, a diamine ethoxylate, a polyglycerol ester, an alkyl ethoxylate, an alcohol that has been polypropoxylated, an alcohol that has been polyethoxylated, an arginine methyl ester, an alkanolamine, an alkylenediamide, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfate, a taurate, an amine oxide, an alkylamine oxide, an ethoxylated amide, an alkoxylated fatty acid, an alkoxylated alcohol, an ethoxylated fatty amine, an ethoxylated alkyl amine, a betaine, a modified betaine, an alkylamidobetaine, a quaternary ammonium compound, an alkyl propoxy-ethoxysulfonate, an alkyl propoxy-ethoxysulfate, an alkylaryl-propoxy-ethoxysulfonate, any combination thereof, and any derivative thereof. Further illustrative surfactants include, but are not limited to, at least one of polyoxyethylene sorbitan monopalmitate, polyoxyethylene sorbitan monostearate, polyoxyethylene sorbitan monooleate, a linear alcohol alkoxylate, an alkyl ether sulfate, dodecylbenzene sulfonic acid, a linear nonyl-phenol, dioxane, ethylene oxide, polyethylene glycol, an ethoxylated castor oil, dipalmitoyl-phosphatidylcholine, sodium 4-(1′ heptylnonyl)benzenesulfonate, polyoxyethylene nonyl phenyl ether, sodium dioctyl sulphosuccinate, tetraethyleneglycoldodecylether, sodium octlylbenzenesulfonate, sodium hexadecyl sulfate, sodium laureth sulfate, ethylene oxide, decylamine oxide, dodecylamine betaine, dodecylamine oxide, any combination thereof, and any derivative thereof.

The electrolyte 210 is not limited by this disclosure, and may generally be any electrolyte. In some embodiments, the electrolyte 210 may generally be an electrolyte exhibiting high ionic conductivity with frequency-independent behavior. For example, high electronic conductivity may be an ionic conductivity that is equal to or greater than about 10⁻³ S cm⁻¹ at 25° C. Such a behavior may result in a liquid-based conductive pathway for ion transport. As previously described herein, in some embodiments, the electrolyte 210 may be a liquid electrolyte. In some embodiments, the electrolyte 210 may include at least one lithium salt. The at least one lithium salt may include at least one of lithium perchlorate, lithium terafluoroborate, lithium hexafluorophosphate, lithium hexafluoroarsenate, and lithium bis(trimethylsilyl)amide. In some embodiments, the electrolyte 210 may include at least one lithium salt at a concentration of about 10% by weight to about 60% by weight of the electrolyte, such as about 10% by weight, about 20% by weight, about 30% by weight, about 40% by weight, about 50% by weight, about 60% by weight, or any value or range between any two of these values (including endpoints). In some embodiments, the electrolyte 210 may further include at least one sodium salt. The at least one sodium salt may include at least one of sodium perchlorate, sodium sulphate and sodium nitrate. In some embodiments, the electrolyte 210 may include at least one sodium salt at a concentration of about 10% by weight to about 60% by weight of the electrolyte, such as about 10% by weight, about 20% by weight, about 30% by weight, about 40% by weight, about 50% by weight, about 60% by weight, or any value or range between any two of these values (including endpoints). In some embodiments, the electrolyte 210 may include a combination of at least one sodium salt and at least one lithium salt at a concentration of about 10% by weight to about 60% by weight of the electrolyte, such as about 10% by weight, about 20% by weight, about 30% by weight, about 40% by weight, about 50% by weight, about 60% by weight, or any value or range between any two of these values (including endpoints). In some embodiments, the lithium salt may have a ratio of ether oxygen atoms to lithium cations of about 3:1 to about 20:1, such as about 3:1, about 5:1, about 7:1, about 10:1, about 12:1, about 15:1, about 18:1, about 20:1, or any value or range between any two of these values (including endpoints). In some embodiments, the electrolyte 210 may further include a dispersing medium, for example, for the lithium salt, the sodium salt or both. The dispersing medium may include at least one of propylene carbonate, ethylene carbonate, dimethyl carbonate, diethyl carbonate, ethanol, tetrahydrofuran, and water.

In some embodiments, the polymer matrix 202 may be a polymer electrolyte having polymer and at least one salt. The polymer can be a high molecular weight polymer in the form of a polymer chain network having a strong entanglement network of polymer chains. The polymer 220 is not limited by this disclosure, and may generally be any polymer, particularly polymers commonly used for gum-like compounds. Illustrative polymers may include, but are not limited to, polyethylene oxide, polyvinylidene difluoride, polymethyl methacrylate, polyvinyl alcohol, polyacrylonitrile, polyvinyl chloride, polyvinyl acetate, any combination thereof, and any derivative thereof. In some embodiments, the polymer matrix may include at least one lithium salt. The at least one lithium salt may include at least one of lithium perchlorate, lithium terafluoroborate, lithium hexafluorophosphate, lithium hexafluoroarsenate, and lithium bis(trimethylsilyl)amide. For example, the polymer matrix 202 may include a high molecular weight poly(ethylene oxide) (PEO), with a lithium salt, such as lithium perchlorate (LiClO₄). The lithium salt may be dispersed in a solution of propylene carbonate at a concentration of about 0.1 M to about 5 M, such as about 0.1 M, about 0.5 M, about 1 M, about 2 M, about 3 M, about 4 M, about 5 M, or any value or range between any two of these values (including endpoints). In some embodiments, the concentration of lithium salt in a solution of propylene carbonate is 1 M.

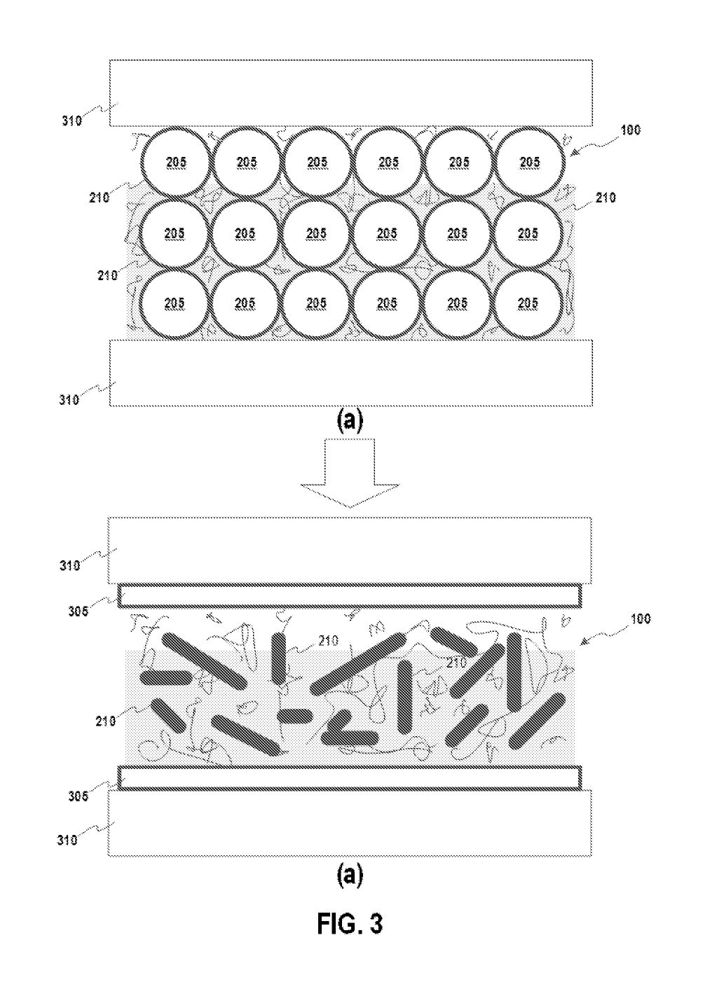

As shown in FIG. 3, the gum-like electrolyte composition 100 may be configured to form a non-conductive layer or barrier between the electrolyte 210 and one or more electrodes 310. Such an ability to form a non-conductive layer or barrier may address various safety issues that are common with electrolytes contacting electrodes at elevated temperatures. Thus, as the temperature of the gum-like electrolyte composition 100 increases, the wax particles 205 may melt and form a wax layer 305 on a surface of an electrode 310. Such a wax layer 305 may adhere to the electrode and may prevent the electrode from contacting the other portions of the gum-like electrolyte composition 100, particularly the electrolyte 210. Accordingly, as previously described herein, the wax particles 205 may have a melting point that is at or near an electrochemical reaction temperature (T_{c}) of the electrolyte 210. In particular embodiments, the melting point of the wax particles 205 may be a temperature that is lower than the T_{c} of the electrolyte 210 to ensure that the wax has melted and formed a layer on the electrode 310 prior to the temperature rising to the T_{c} of the electrolyte.

In various embodiments, the formation of the wax layer 305 on an electrode 310 may be tested by measuring a contact angle of the electrode surface. In some embodiments, when a wax layer 305 is formed on the electrode 310, a high contact angle is observed. The contact angle, or the angle where a liquid and/or a vapor interface meets a solid surface, may be a high contact angle when it is any angle greater than or equal to about 100°, such as about 105°, about 110°, about 115°, about 120°, about 125°, about 130°, about 135°, about 140°, about 145°, about 150°, about 155°, about 160°, about 165°, about 170°, or any value or range between any two of these values.

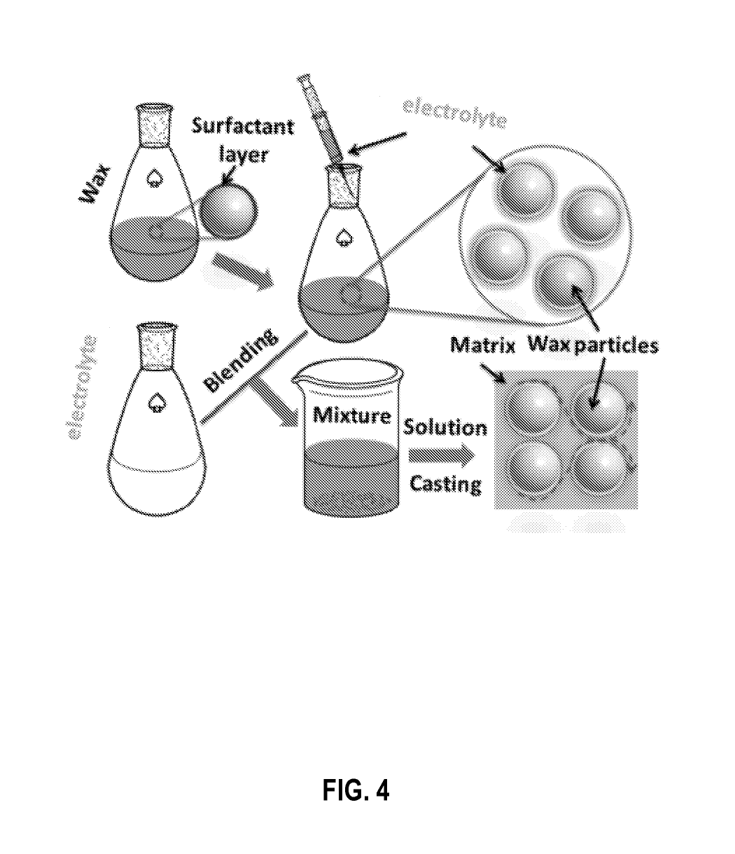

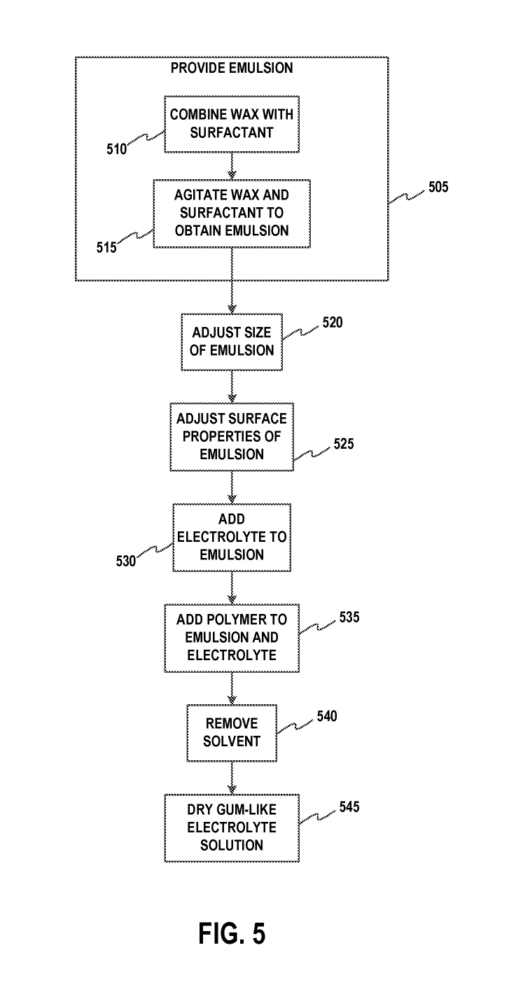

FIG. 4 and FIG. 5 depict an illustrative schematic diagram and flow diagram of a method of forming a gum-like electrolyte composition, respectively, according to an embodiment. As shown in FIG. 5, a wax emulsion is provided 505. The wax emulsion may generally be a wax emulsion as described in greater detail herein, including, for example, a wax suspension where the wax particles are suspended in a liquid medium. In some embodiments, the wax emulsion may be provided by combining 510 a wax with a surfactant and agitating 515 the wax and the surfactant. Agitation 515 is not limited by this disclosure, and may be any method of applying energy to the combination. Illustrative methods of agitation 515 may include, but are not limited to, ultrasonication, bath sonication, high-pressure homogenization, microfluidization, and/or the like. In some embodiments, the combination may be agitated 515 for a period of time, such as, for example, 1 minute, 5 minutes, 10 minutes, 30 minutes, or more. In some embodiments, the wax and the surfactant may be agitated 515 at a temperature, such as, for example, about 50° C., about 60° C., about 70° C., about 80° C., about 90° C., about 100° C. or higher. In some embodiments, a resultant wax emulsion may have a weight fraction of solid components in the wax emulsion, such as, for example, about 5%, about 10%, about 15%, about 20%, about 25%, about 30%, about 40%, about 50%, or any value or range between any two of these values (including endpoints). In some embodiments, a resultant emulsion may provide one or more wax particles having the surfactant at surfaces of the particles that are suitable for receiving an electrolyte composition shell, as described in greater detail herein. In some embodiments, the surfactant on the wax surface may determine an interfacial energy of the interface between the particles and the polymer matrix. For example, smaller particles and a sharp interface between the particles and the polymer matrix may correspond to a high interfacial energy, which drives an absorption of the electrolyte composition onto the surface of the particles. As a result, formation of an electrolyte composition shell on the particles may reduce the interfacial energy and stabilize the structures.

In various embodiments, the size of various wax particles may be adjusted 520 after the emulsion is provided 505. The size may be adjusted 520 to ensure a size that allows for the wax particles to receive an electrolyte composition shell, as described in greater detail herein. In some embodiments, the size of the particles may affect a packing structure of the particles, various mechanical properties, ionic conductivity, and/or adhesion properties of the gum-like electrolyte compositions. In some embodiments, the size and distribution of the particles may be controlled with one or more surfactants, various processing equipment, and controlling various conditions of the wax emulsion, such as a sonication power and/or a time. In some embodiments, the size may be adjusted 520 such that the wax particles have an average diameter of about 0.1 μm to about 10 μm, such as about 0.1 μm, about 0.2 μm, about 0.3 μm, about 0.4 μm, about 0.5 μm, about 0.6 μm, about 0.7 μm, about 0.8 μm, about 0.9 μm, about 1.0 μm, about 1.5 μm, about 2 μm, about 3 μm, about 4 μm, about 5 μm, about 6 μm, about 7 μm, about 8 μm, about 9 μm, about 10 μm, or any value or range between any two of these values (including endpoints).

In various embodiments, various surface properties of the wax particles may be adjusted 525 after the emulsion is provided 505. The surface properties may be adjusted 525 to ensure properties that allow for the wax particles to receive an electrolyte composition shell, as described in greater detail herein. In some embodiments, the surfactant on the wax surface may determine various surface properties of the particles as well as various interface properties between the particles and the polymer matrix. The particle surface, which may form a sharp interface with the polymer matrix and/or may have a strong affinity to the electrolyte, may facilitate formation of an electrolyte shell on the particles, may improve ionic conductivity of the gum-like electrolyte compositions and/or may improve various mechanical properties of the gum-like electrolyte compositions.

In some embodiments, adjusting 520 the size of the wax particles and/or adjusting 525 the surface properties of the wax particles may be controlled during the forming of the wax emulsion. Thus, in some embodiments, it may not be necessary to resize and/or reshape the wax particles subsequent to providing the wax emulsion. Those skilled in the art will recognize various methods for combining waxes with surfactants and agitating the combination to result in wax particles having desirable size and surface properties as described herein.

In various embodiments, an electrolyte may be added 530 to the wax emulsion. Such an addition 530 may result in an electrolytic wax emulsion containing the electrolyte and the wax emulsion. In some embodiments, the electrolytic wax emulsion may generally include a plurality of cores of wax particles, each surrounded by a shell containing the electrolyte, as described in greater detail herein. In some embodiments, the electrolyte may be a liquid electrolyte. In some embodiments, the electrolyte may be a liquid electrolyte containing a salt, such as a lithium salt, a sodium salt, or both, as described in greater detail herein. In various embodiments, the salt may be present in the electrolyte in a concentration of about 0.1 M to about 5 M, such as about 0.1 M, about 0.5 M, about 1 M, about 2 M, about 3 M, about 4 M, about 5 M, or any value or range between any two of these values (including endpoints).

In some embodiments, the electrolyte may be added 530 to the wax emulsion via a percolation method. Those with ordinary skill in the art will recognize various percolation methods that will be suitable for adding 530 the electrolyte to the wax emulsion, as described herein. In some embodiments, adding 530 the electrolyte to the wax emulsion may include agitating the mixture for a period of time and at a temperature. Agitation is not limited by this disclosure and may include any method of agitation. Illustrative agitation methods may include, but are not limited to, bath sonication, spin mixing, and/or the like. The period of time is not limited by this disclosure and may be any period of time suitable to allow coating of the wax particles in the wax emulsion with the electrolyte. Similarly, the temperature is not limited by this disclosure and may be any temperature suitable to allow coating of the wax particles in the wax emulsion with the electrolyte. Illustrative temperatures may include about 1° C. to about 100° C., such as about 1° C., about 10° C., about 20° C., about 30° C., about 40° C., about 50° C., about 60° C., about 70° C., about 80° C., about 90° C., about 100° C., or any value or range between these values (including endpoints).

In some embodiments, particularly embodiments where the wax emulsion is a wax suspension as described herein, adding 530 the electrolyte to the wax suspension may include spraying a liquid electrolyte onto at least one wax particle in the wax suspension. A resultant electrolytic wax emulsion may be a plurality of cores of wax particles surrounded by a shell of electrolyte composition, as described herein.

In various embodiments, a polymer solution may be added 535 to the electrolytic wax emulsion. Adding 535 the polymer solution to the electrolytic wax emulsion may result in a mixture. In some embodiments, the polymer solution may include at least a polymer and a solvent. The polymer solution may further include a salt. The polymer may generally be any polymer described herein. The solvent is not limited by this disclosure and may generally be any solvent, particularly solvents suitable as carriers for the various polymers described herein. Illustrative solvents may include, but are not limited to, water, acetonitrile, dimethylformamide, chloroform, propylene carbonate, ethylene carbonate, dimethyl carbonate, diethyl carbonate, and/or any combination thereof. The water may be any type of water, including deionized water, distilled water, and/or the like. The salt may generally be any salt, particularly salts described herein. In various embodiments, the mixture may have a weight ratio of wax particles to the polymer of about 1:20 to about 20:1, such as about 1:20, about 1:10, about 1:1, about 10:1, about 20:1, or any value or range between any two of these values (including endpoints).

In various embodiments, the solvent may be removed 540 from the mixture to obtain the gum-like electrolyte composition. The solvent may generally be removed 540 via any method of solvent removal now known or later developed. An illustrative method of removing 540 the solvent may be via a solution casting method in a hood. Those with ordinary skill in the art will recognize that any suitable method for removing solvents may be used, such as, for example, removing the solvents via an evaporation process.

In various embodiments, the gum-like electrolyte composition may be dried 545 to obtain the final product. In some embodiments, the gum-like electrolyte composition may be vacuum dried. For example, the gum-like electrolyte composition may be vacuum dried at a pressure and a temperature for a period of time. The pressure is not limited by this disclosure and may be any pressure, such as about 5 kPa to about 50 kPa, such as about 5 kPa, about 10 kPa, about 15 kPa, about 20 kPa, about 25 kPa, about 30 kPa, about 35 kPa, about 40 kPa, about 45 kPa, about 50 kPa, or any value or range between any two of these values (including endpoints). Likewise, the temperature is not limited by this disclosure and may be any temperature, particularly temperatures suitable for vacuum drying. Illustrative temperatures may include, for example, about 25° C., about 30° C., about 35° C., about 40° C., about 45° C., about 50° C., or any value or range between any two of these values (including endpoints).

### EXAMPLES

### Example 1

### Preparation of a Gum-Like Electrolyte Composition

The materials employed for the gum-like electrolyte composition included lithium perchlorate salt (LiClO₄), poly(ethylene oxide) (PEO, Mₙ=4×10⁶ g/mol), paraffin wax (melting point of 68° C.), propylene carbonate, a surfactant including a copolymer of polyethylene oxide and polyethylene (PEO-PE), and a surfactant including sorbitan monostearate.

A wax emulsion with a surfactant containing a mixture of PEO-PE and paraffin wax was prepared. The wax emulsion contained 15% by weight of the PEO-PE and 85% by weight of the paraffin wax. The emulsion was prepared via ultrasonication at 80° C. for 10 minutes. A resulting weight fraction of the solid components in the wax emulsion was 10% by weight. At substantially the same time that the wax emulsion was being formed, a PEO solution in deionized (DI) water was prepared.

A quantified liquid electrolyte containing PC/LiClO₄ was introduced into the wax emulsion and was treated under bath sonication at room temperature for 10 minutes. A concentration of the lithium salt in the liquid electrolyte was 1 M.

The wax emulsion containing the liquid electrolyte was blended with the PEO solution. The resultant mixture had a weight ratio of wax particles (including the surfactant) to the polymer matrix of 2:1. The mixture was stirred at room temperature for 30 minutes.

The solvent (DI water) was removed from the mixture via solution casting at room temperature and vacuum dried at 15 kPa for 24 hours at 35° C. to obtain the gum-like electrolyte composition. The final loading of the liquid electrolyte in the gum-like electrolyte composition was about 40% by weight to about 60% by weight as determined by the weight after drying.

### Example 2

### Energy Dispersive X-Ray Spectroscopy (EDS) Mapping

EDS mapping was performed to confirm that the liquid electrolyte was successfully located at the surface of the wax particles so that a core-shell structure was formed in the method described above with respect to Example 1. The EDS mapping was performed on a field-emission scanning electron microscope (FESEM) equipped with an Oxford ISIS energy dispersive X-ray detector.

Samples for EDS mapping were prepared. In order to obtain a mapping of the cations, sodium perchlorate was used since because lithium signals cannot be detected by the EDS detector. The wax emulsion mixture containing the liquid electrolyte from Example 1 was diluted and dispersed on a carbon-based paper sheet to obtain a single layer of wax particles. The paper sheet with wax particles was coated with gold for EDS mapping.

The EDS mapping indicated a denser distribution of sodium and chlorine on the surface of the particles as compared with those in polymer matrix. An uneven distribution of sodium perchlorate provided an indication of a formation of an electrolyte shell on the particle surface.

### Example 3

### Impedance Analysis

The ion conductivity of the gum-like electrolyte composition prepared according to Example 1 was obtained by AC impedance spectroscopy measurements. The frequency range was chosen to be about 10⁻¹ Hz to about 10⁶ Hz. The electrolyte composition sample was placed between two gold electrodes having a diameter of about 2 cm. The input voltage for the measurement was about 1V. To evaluate the thermal protection capability, the measurements were carried out at different temperatures ranging from about 20° C. to about 80° C.

The gum-like electrolyte composition showed a liquid-like conductive behavior in a high frequency range (about 10⁴ Hz to about 10⁶ Hz) and possessed an ionic conductivity of about 10⁻³ S cm⁻¹ at 25° C. When the temperature was higher than the melting point of the wax particles (about 68° C.), the ionic conductivity decreased with the increasing temperature. This result indicated a thermal-protection capability of the gum-like electrolyte composition at a high temperature because the melted wax particle blocked transportation of lithium ions between the electrolyte and the electrode by forming a non-conductive barrier between the electrolyte and the electrode.

### Example 4

### Mechanical Testing

Mechanical properties of the gum-like electrolyte composition prepared according to Example 1 were identified by rheological testing. A parallel plate with a diameter of about 25 mm and a testing gap (the thickness of the sample) of about 0.5 mm to about 1 mm was used. A frequency sweep of about 0.05 Hz to about 100 Hz was carried out at room temperature to determine dynamic mechanical properties of the gum-like electrolyte composition. For rheological testing, the strain was 1%, which is in a linear viscoelastic region of all samples that were tested. At the same time, a control test of common chewing gum was conducted under the same conditions.

The typical modulus of the gum-like electrolyte composition was found to be similar to that of a common chewing gum. Accordingly, the modulus was found to be about 0.1 MPa at a frequency of 5 Hz. The surfactant on the particle surface and particle loading were found to be important to control various mechanical properties. For example, as compared with a copolymer surfactant such as PEO-PE, sucrose distearate resulted in a gum-like electrolyte composition with a higher modulus (0.5 MPa at a frequency of 5 Hz). At the same time, a higher loading of particles improved various mechanical properties but decreased the ionic conductivity.

### Example 5

### Adhesion Testing

An experiment was completed to determine an adhesion strength of the gum-like electrolyte composition prepared according to Example 1. For comparison, a control gum substance was tested as well. A fixed substrate having a flat plastic plate and levelly fixed on a table was provided. The weight against the adhesion was controlled by a steel substrate with an effective surface area of 9.42 cm². The weight of the steel substrate was configured to be continuously adjusted. The two substrates were cleaned with acetone before the testing samples were placed thereon. To obtain a reliable result, each testing sample was evenly coated on the plastic substrate with the steel substrate fixed with a container also bonded to each sample by a constant weight of about 8 kg for 5 minutes. The maximum weight that each sample could hold was recorded and repeated 7 times.

The gum-like electrolyte composition showed an adhesion strength of about 0.34 MPa, which is about two times of that of a typical chewing gum. The strong adhesion property indicated a good contact between the gum-like electrolyte composition and the substrate. At the same time, the gum-like electrolyte composition was found to be able to adhere to any substrate.

### Example 6

### Polarized Light Microscopy (PLM) and Scanning Electron Microscopy (SEM)

The morphology of the gum-like electrolyte composition prepared in accordance with Example 1 was analyzed using a polar light microscope at room temperature. In addition, the surface morphology of the gum-like electrolyte composition was analyzed using a scanning electron microscope. To observe the contact behavior between the gum-like electrolyte composition on an electrode material, an electrode made of Vanadium (V) oxide (V₂O₅) was prepared. The electrode was prepared by oxidizing vanadium at 500° C. for 4 hours. The gum-like electrolyte composition was adhered to the surface of the electrode without compression for the SEM observation.

The PLM images indicated that the gum-like electrolyte composition possessed multi-network structures. The SEM images revealed a uniform particle distribution in the final gum-like electrolyte composition. The SEM images of the interface between the gum-like electrolyte composition and V₂O₅ electrode displayed a void-free contact between the gum-like electrolyte composition and the V₂O₅.

### Example 7

### Contact Angle Testing

An OCA 15 Plus Contact Angle Analyzer (DataPhysics Instruments GmbH, Filderstadt, Germany) was used to perform contact angle testing of the gum-like electrolyte composition prepared in accordance with Example 1. The gum-like electrolyte composition was applied to a gold electrode cleaned with acetone. The contact angle was determined by an average value of 5 measurements conducted at room temperature. To confirm that a wax layer was present on the electrode surface at a high temperature (particularly at a temperature higher than the melting point of the wax), two gold electrodes with the gum-like electrolyte composition placed therebetween were heated to about 80° C. for 1 minute and were separated from the gum-like electrolyte composition at the high temperature. The surface separated from the gum-like electrolyte composition was used for contact angle testing. To investigate the uniformity of the wax layer on the gold electrode, the contact angle was measured at 10 different locations.

Results indicated that the gold surface became hydrophobic after the high temperature treatment, indicating that a wax layer formed between the gum-like electrolyte composition and the electrode at a temperature higher than the melting point of the wax particles.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of forming a gum-like electrolyte composition, the method comprising:
generating a wax emulsion;
adding at least one electrolyte to the wax emulsion to obtain an electrolytic wax emulsion;
adding a polymer solution to the electrolytic wax emulsion to obtain a mixture, wherein the polymer solution comprises a polymer and a solvent; and
removing the solvent from the mixture to obtain a gum-like electrolyte composition.

2. (canceled)

3. The method of claim 1, wherein generating the wax emulsion comprises:
combining a wax with a surfactant; and
agitating the wax and the surfactant to obtain the wax emulsion.

4. The method of claim 3, wherein the combining a wax with a surfactant comprises combining a wax selected from the group consisting of paraffin, paraffin wax, soy wax, polypropylene, polyethylene, polystyrene, montan wax, candelilla wax, carnauba wax, beeswax, polyethylene wax, and maleated hydrocarbons.

5. The method of claim 3, wherein the combining a wax with a surfactant comprises combining a surfactant selected from the group consisting of a polyethylene-block-poly(ethylene glycol), a lithium dodecyl sulfate, sodium dodecyl sulfate, a sucrose distearate, a sucrose monostearate, a phosphatidylethanolamine, a polyacrylic acid, a polyethylacetate, a dimethylacrylamide, an n-isopropylacrylamide, a polyvinylpyrrolidone, a polyethyleneimine, sorbitan, an alkyl polyglycoside, a sorbitan ester, a methyl glucoside ester, an amine ethoxylate, a diamine ethoxylate, a polyglycerol ester, an alkyl ethoxylate, an alcohol that has been polypropoxylated, an alcohol that has been polyethoxylated, an arginine methyl ester, an alkanolamine, an alkylenediamide, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfate, a taurate, an amine oxide, an alkylamine oxide, an ethoxylated amide, an alkoxylated fatty acid, an alkoxylated alcohol, an ethoxylated fatty amine, an ethoxylated alkyl amine, a betaine, a modified betaine, an alkylamidobetaine, a quaternary ammonium compound, an alkyl propoxy-ethoxysulfonate, an alkyl propoxy-ethoxysulfate, an alkylaryl-propoxy-ethoxysulfonate, and any derivative thereof.

6. (canceled)

7. (canceled)

8. The method of claim 3, wherein agitating the wax and the surfactant comprises agitating via at least one of ultrasonication, high-pressure homogenization, and microfluidization.

9.-12. (canceled)

13. The method of claim 1, wherein the adding the at least one electrolyte comprises adding an electrolyte having at least one lithium salt.

14. (canceled)

15.-27. (canceled)

28. A gum-like electrolyte composition comprising:
a malleable material comprising a mixture of:
at least one wax particle;
at least one electrolyte; and
a polymer matrix comprising at least one polymer,
wherein the wax particle and the electrolyte are dispersed in the polymer matrix.

29. The gum-like electrolyte composition of claim 28, wherein the at least one wax particle is at least substantially encased by the at least one electrolyte to form at least one core-shell particle.

30.-31. (canceled)

32. The gum-like electrolyte composition of claim 28, wherein the at least one wax particle is selected from the group consisting of paraffin, paraffin wax, soy wax, polypropylene, polyethylene, montan wax, candelilla wax, carnauba wax, beeswax, polyethylene wax, and maleated hydrocarbons.

33. The gum-like electrolyte composition of claim 28, wherein the at least one wax particle comprises a surfactant.

34. The gum-like electrolyte composition of claim 33, wherein the surfactant is selected from the group consisting of a polyethylene-block-poly(ethylene glycol), a lithium dodecyl sulfate, sodium dodecyl sulfate, a sucrose distearate, a sucrose monostearate, a phosphatidylethanolamine, a polyacrylic acid, a polyethylacetate, a dimethylacrylamide, an n-isopropylacrylamide, a polyvinylpyrrolidone, a polyethyleneimine, sorbitan, an alkyl polyglycoside, a sorbitan ester, a methyl glucoside ester, an amine ethoxylate, a diamine ethoxylate, a polyglycerol ester, an alkyl ethoxylate, an alcohol that has been polypropoxylated, an alcohol that has been polyethoxylated, an arginine methyl ester, an alkanolamine, an alkylenediamide, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfate, a taurate, an amine oxide, an alkylamine oxide, an ethoxylated amide, an alkoxylated fatty acid, an alkoxylated alcohol, an ethoxylated fatty amine, an ethoxylated alkyl amine, a betaine, a modified betaine, an alkylamidobetaine, a quaternary ammonium compound, an alkyl propoxy-ethoxysulfonate, an alkyl propoxy-ethoxysulfate, an alkylaryl-propoxy-ethoxysulfonate, and any derivative thereof.

35. (canceled)

36. The gum-like electrolyte composition of claim 28, wherein the polymer is selected from the group consisting of polyethylene oxide, polyvinylidene difluoride, polymethyl methacrylate, polyvinyl alcohol, polyacrylonitrile, polyvinyl chloride, polyvinyl acetate, and any derivative thereof.

37. The gum-like electrolyte composition of claim 28, further comprising at least one lithium salt.

38. The gum-like electrolyte composition of claim 37, wherein the at least one lithium salt is selected from the group consisting of lithium perchlorate, lithium terafluoroborate, lithium hexafluorophosphate, lithium hexafluoroarsenate, and lithium bis(trimethylsilyl)amide.

39.-43. (canceled)

44. The gum-like electrolyte composition of claim 42, wherein the at least one lithium salt is selected from the group consisting of lithium perchlorate, lithium terafluoroborate, lithium hexafluorophosphate, lithium hexafluoroarsenate, and lithium bis(trimethylsilyl)amide.

45. The gum-like electrolyte composition of claim 28, wherein the electrolyte further comprises at least one sodium salt.

46. The gum-like electrolyte composition of claim 45, wherein the at least one sodium salt is selected from the group consisting of sodium perchlorate, sodium sulphate and sodium nitrate.

47.-50. (canceled)

51. The gum-like electrolyte composition of claim 28, wherein the electrolyte comprises a combination of at least one lithium salt and at least one sodium salt.

52.-85. (canceled)

86. A gum-like electrolyte composition comprising:
a malleable material comprising a polymer matrix having dispersed therein a wax particle; an electrolyte; and a surfactant.

87. The gum-like electrolyte composition of claim 86, wherein the wax particle is selected from the group consisting of paraffin, paraffin wax, soy wax, polypropylene, polyethylene, montan wax, candelilla wax, carnauba wax, beeswax, polyethylene wax, and maleated hydrocarbons.

88. The gum-like electrolyte composition of claim 86, wherein the polymer matrix comprises a polymer is selected from the group consisting of polyethylene oxide, polyvinylidene difluoride, polymethyl methacrylate, polyvinyl alcohol, polyacrylonitrile, polyvinyl chloride, polyvinyl acetate, and any derivative thereof.

89. The gum-like electrolyte composition of claim 86, wherein the polymer matrix further comprises at least one lithium salt.

90. A method of forming a gum-like electrolyte composition, the method comprising:
forming a wax emulsion by combining a wax and a surfactant under agitation;
adding an electrolyte to the wax emulsion to obtain an electrolytic wax emulsion;
adding a polymer solution to the electrolytic wax emulsion to obtain a mixture, wherein the polymer solution comprises a polymer and a solvent; and
removing the solvent from the mixture to obtain a gum-like electrolyte composition.

91. The method of claim 90, wherein forming the wax emulsion comprises agitating the wax and the surfactant by an agitation method selected from the group consisting of ultrasonication, high-pressure homogenization, and microfluidization.

92. The method of claim 90, wherein adding the electrolyte to the wax emulsion comprises adding an electrolyte having at least one lithium salt.
